(19) United States
(12) Patent Application Publication
(10) Pub. No.: US 2024/0430933 A1
(43) Pub. Date: Dec. 26, 2024

(54) METHODS AND APPARATUS FOR MULTIPLE SIDELINK CHANNEL OCCUPANCY TIME SHARING

(71) Applicant: QUALCOMM Incorporated, San Diego, CA (US)

(72) Inventors: Luanxia YANG, Beijing (CN); Jing SUN, San Diego, CA (US); Changlong XU, Beijing (CN); Xiaoxia ZHANG, San Diego, CA (US); Shaozhen GUO, Beijing (CN); Siyi CHEN, Beijing (CN); Hao XU, Beijing (CN)

(21) Appl. No.: 18/710,485

(22) PCT Filed: Jan. 29, 2022
(86) PCT No.: PCT/CN2022/074908

§ 371 Date: May 15, 2024

(51) Int. Cl. H04W 74/0808; H04W 72/25

(52) U.S. Cl. CPC H04W 74/0808; H04W 72/25

(57) ABSTRACT

Aspects of the present disclosure include methods, apparatuses, and computer readable media for receiving channel occupancy time (COT) sharing information associated with COT sharing resources from a plurality of initiating UEs via a plurality of sidelink (SL) communication channels, and forwarding the COT sharing information to a plurality of responding devices.

### FIELD OF INVENTION

Aspects of the present disclosure relate generally to wireless communications, and more particularly, to apparatuses and methods for multiple sidelink channel occupancy time sharing.

### BACKGROUND

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, a user equipment (UE) or a base station (BS) may share channel occupancy time (COT) resources so other devices may utilized the COT sharing resources for uplink (UL), downlink (DL), or sidelink (SL) transmissions or receptions. In some instances, one or more user equipment (UEs) may transmit control information relating to the COT sharing resources to a same responding device, such as another UE or a base station (BS). However, it is unclear how the responding device responds after receiving the control information. Therefore, improvements are desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods by a user equipment (UE) for receiving channel occupancy time (COT) sharing information associated with COT sharing resources from a plurality of initiating UEs via a plurality of sidelink (SL) communication channels, and forwarding the COT sharing information to a plurality of responding devices.

Other aspects of the present disclosure include a user equipment (UE) having a memory comprising instructions, a transceiver, and one or more processors operatively coupled with the memory and the transceiver, the one or more processors configured to execute instructions in the memory to receive channel occupancy time (COT) sharing information associated with COT sharing resources from a plurality of initiating UEs via a plurality of sidelink (SL) communication channels, and forward the COT sharing information to a plurality of responding devices.

An aspect of the present disclosure includes a user equipment (UE) including means for receiving channel occupancy time (COT) sharing information associated with COT sharing resources from a plurality of initiating UEs via a plurality of sidelink (SL) communication channels, and means for forwarding the COT sharing information to a plurality of responding devices.

Some aspects of the present disclosure include non-transitory computer readable media having instructions stored therein that, when executed by one or more processors of a user equipment (UE), cause the one or more processors to receive channel occupancy time (COT) sharing information associated with COT sharing resources from a plurality of initiating UEs via a plurality of sidelink (SL) communication channels, and forward the COT sharing information to a plurality of responding devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure;

FIG. 2 is a schematic diagram of an example of a user equipment according to aspects of the present disclosure;

FIG. 3 is a schematic diagram of an example of a base station according to aspects of the present disclosure;

FIG. 4 illustrates an example of an environment for managing multiple sidelink channel occupancy time sharing according to aspects of the present disclosure;

FIG. 5 illustrates examples of COT sharing resources allocated by initiating UEs according to aspects of the present disclosure;

FIG. 6 illustrates an example of forwarding COT sharing resources according to aspects of the present disclosure; and

FIG. 7 illustrates an example of a method for COT resource sharing according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In some aspects, channel occupancy time (COT) sharing between base stations (BSs) and user equipments (UEs) may provide improved medium access from one node to another. During downlink (DL) to uplink (UL) COT sharing, a BS may acquire a COT with extended clear channel assessment (eCCA) and share with multiple UEs for the UEs to transmit UL signals. Within the COT, the UEs may use single shot CCA or listen-before-talk (LBT) for UL transmission. In some instances, category 2 LBT may be used for DL to UL gaps of 16 μs and/or 25 μs. In other instances, category 1 LBT may be used when the DL to UL gap is less than or equal to 16 μs.

In some implementations, UL to DL COT sharing may be supported. For example, the BS may share a UE-initiated COT (either configured grant physical uplink shared channel (CG-PUSCH) or scheduled UL). The BS may transmit control/broadcast signals and/or channels for any UE if the transmission includes information for the UE initiating the COT. The BS may transmit DL signals/channels (e.g., physical downlink shared channel (PDSCH), physical downlink control channel (PDCCH), reference signals, etc.) meant for the UE initiating a channel occupancy. The energy determination (ED) threshold that the UE applies when initiating a channel occupancy to be shared with the BS may be configured by the BS (e.g., via radio resource control signaling). If the ED threshold that the UE applies when initiating a channel occupancy to be shared with the BS is not configured, the transmission of the BS in the UE initiated COT may include control/broadcast signals/channels transmissions (e.g., up to 2/4/8 OFDM symbols in duration for 15/30/60 kHz subcarrier spacing (SCS)). In other instances, in the absence of regulation, the ED threshold that the BS provides to configure the UE may be determined based on the maximum BS transmission power. In some instances, category 2 LBT may be used for UL to DL gaps of 16 μs and/or 25 μs. In other instances, category 1 LBT may be used when the UL to DL gap is less than or equal to 16 μs.

In some aspects, the CG-UL to DL COT sharing may be supported. When the UL to DL COT sharing ED threshold is configured, the BS may configure a table for the sharing parameters. Each row of the table may include one or more of the number of slots (D) where DL transmission may be assumed within the UE initiated COT, the DL offset (O) indicating the starting slot of the DL transmission in the number of slots from the end of the slot (where the indicated D is greater than 0), and/or the channel access priority class (CAPC) of the traffic. One row of the table may indicate no COT sharing information. The uplink control information (UC) may be repurposed for COT sharing. When the UL to DL COT sharing ED threshold is not configured, the CG-UCI may carry a 1-bit COT sharing indication, indicating if the slot/symbol n+X is an applicable slot for UL to DL sharing. Here, X is the number of symbols from the end of the slot where the CG-UCI is transmitted, and may be configured by the BS as part of the RRC configuration.

In certain aspects, there may be two or more resource allocations modes for SL communications (e.g., PC5). In mode 1, the BS may allocate resources for SL communication between two or more UEs. In mode 2, the UEs may autonomously select SL resources for SL communication. The signaling on the SL may be the same or different between the two modes.

In an aspect, in mode 1, the BS may provide a dynamic grant or may activate a configured SL grant for SL communications. The SL feedback may be reported back to the BS by the transmitting UE. In mode 2, SL communication may be scheduled by SL control information (SCI). The SCI may be provided in stages. The first stage control information (e.g., SCI-1) may be transmitted on PSCCH. The first stage control information may include information for resource allocation and/or decoding the second stage control information. The first stage control information may include at least one of a priority, PSSCH resource assignment, a resource reservation period (if enabled), PSSCH demodulation reference signal (DMRS) pattern (if configured), a second stage SCI format (e.g., the size of the second SCI), an amount of resources for the second SCI, a number of PSSCH DMRS ports, modulation and coding scheme (MCS), etc. The second stage control information (e.g., SCI-2) may be transmitted on PSCCH and/or include information for decoding PSSCH. The second stage control information may include a layer 1 (L1) destination ID (e.g., 16 bits), a L1 source ID (e.g., 8 bits), a hybrid automatic repeat request (HARQ) process ID, a new data indicator (NDI), and/or a redundancy version (RV).

In one aspect of the present disclosure, the UE may perform channel access procedure prior to SL transmission. The UE may share SL COT with other UEs for SL or UL transmission, or with the BS for DL transmission.

In some aspects of the present disclosure, a UE may receive multiple COT sharing information from multiple COT initiating UEs. The UE may forward at least a portion of the multiple COT sharing information to one or more responding UEs. The one or more responding UEs may utilize the resources indicated by the COT sharing information for UL, DL, and/or SL.

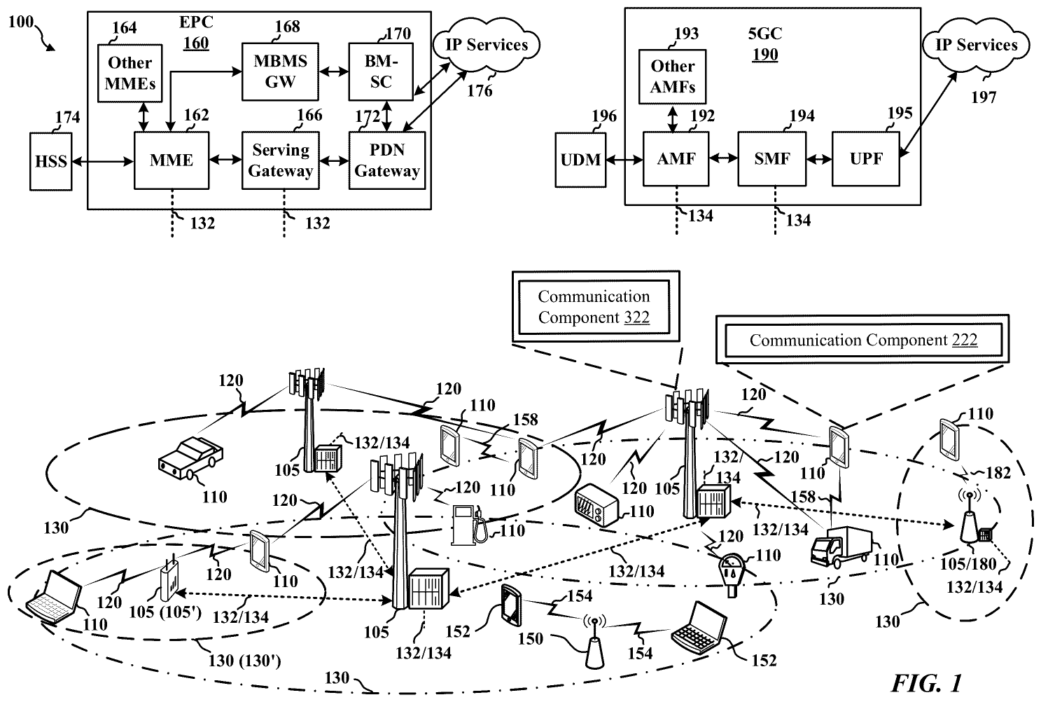

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless and/or wired networks. In some implementations, the communication component 222 may be implemented using hardware, software, or a combination of hardware and software. In some implementations, the BS 105 may include a communication component 322 configured to communicate with the UE 110 via a cellular network, a Wi-Fi network, or other wireless and/or wired networks. In some implementations, the communication component 322 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Y. MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

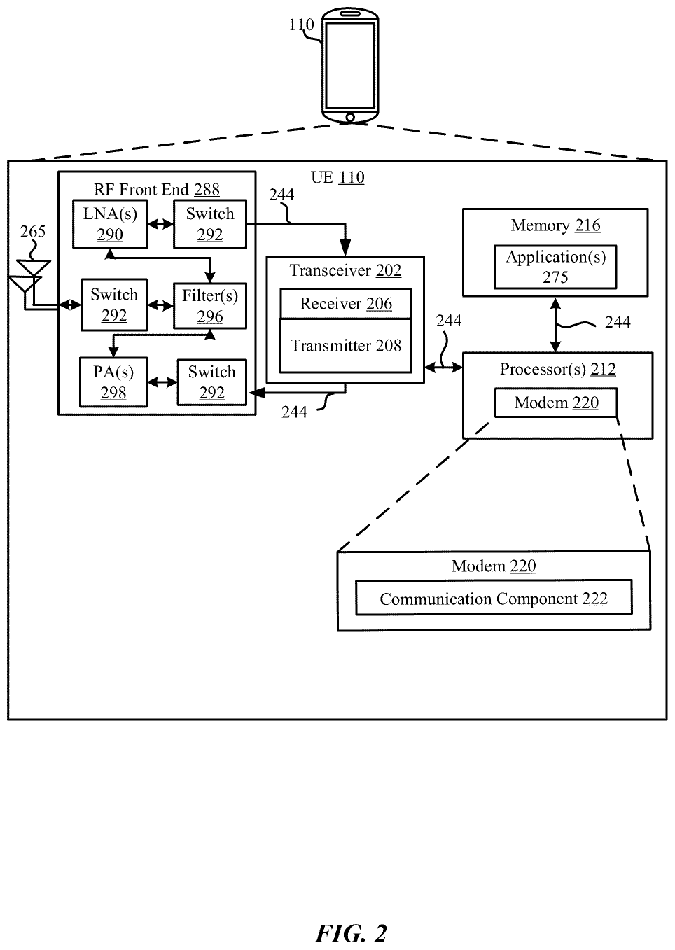

Referring to FIG. 2, one example of an implementation of the UE 110 may include a modem 220 having the communication component 222. In one implementation, the UE 110 may include a communication component 222 configured to communicate with the BS 105 via a cellular network, a Wi-Fi network, or other wireless and wired networks.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The memory 216 may be configured to store data used and/or local versions of application 275. Also, the memory 216 may be configured to store data used herein and/or local versions of the communication component 222, and/or one or more of the subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222, and/or one or more of the subcomponents, and/or data associated therewith, when UE 110 is operating at least one processor 212 to execute the communication component 222, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

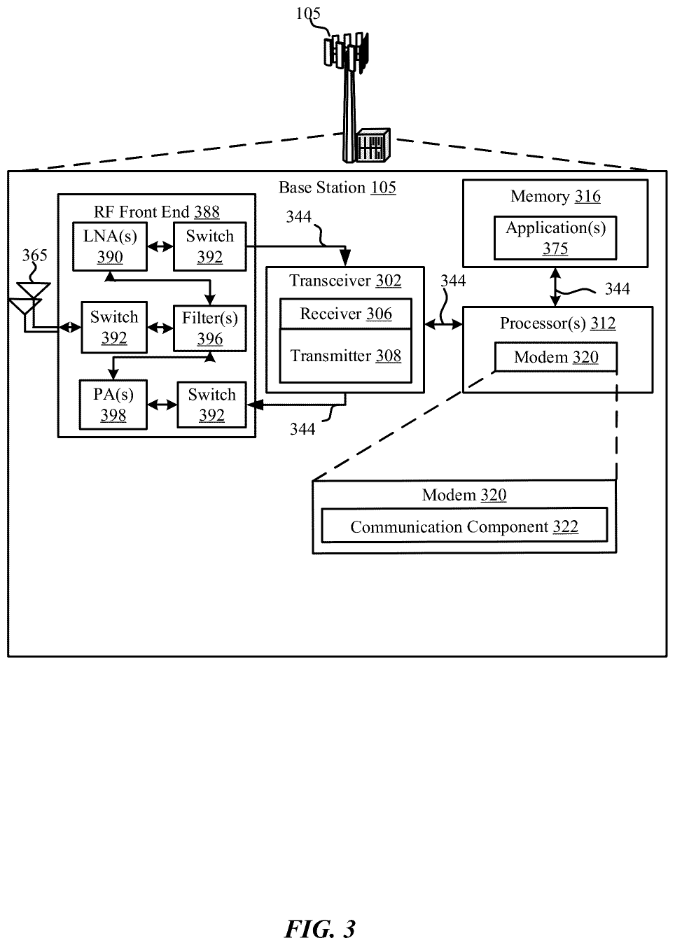

Referring to FIG. 3, one example of an implementation of the BS 105 may include a modem 320 having the communication component 322. In some implementations, the BS 105 may include a communication component 322 configured to communicate with the UE 110.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The memory 316 may be configured to store data used herein and/or local versions of applications 375. Also, the memory 316 may be configured to store data used herein and/or local versions of the communication component 322, and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322, and/or one or more of the subcomponents, and/or data associated therewith, when the BS 105 is operating at least one processor 312 to execute the communication component 322, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

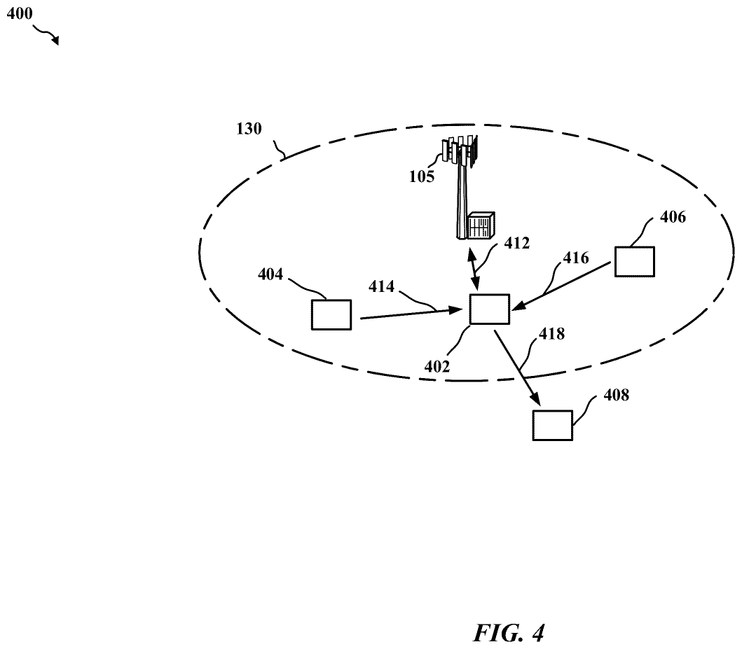

FIG. 4 illustrates an example of an environment for managing multiple sidelink channel occupancy time sharing. In some aspects of the present disclosure, a device may forward COT sharing information from multiple initiating devices to a set of responding devices for DL/UL/SL transmission. The initiating devices may be SL devices. The responding devices may be UE (SL or UL) or BS (DL). The device may receive the COT-SI in SCI from the SL transmission. In some cases, the responding devices may determine how to use the COT sharing resources. The responding devices may determine when to start the transmission. Alternatively, the device may control and/or configure the starting position to control the prioritization of SL, UL, and DL.

In one aspect of the present disclosure, the device may determine whether the COT sharing resources are used for SL, UL, DL, or a combination thereof. The responding devices may indicate the priority of the associated traffic to the responding device. The device may embed one or more bit fields in the COT-SI indicating the type of transmission eligible to share the COT. The device may divide the COT sharing resources into more than one region to support different types of transmissions separately.

In some aspects of the present disclosure, the BS 105 may communicate 412 with a device 402. The device 402 may be a UE, a BS, an IoT device, or other wireless communication devices. A first COT initiating device 404 may transmit first COT sharing information 414 to the device 402. A second COT initiating device 406 may transmit second COT sharing information 416 to the device 402. Each of the first COT initiating device 404 and/or the second COT initiating device 406 may be a UE, a BS, an IoT device, or other wireless communication devices. The device 402 may transmit third COT sharing information 418 to at least one responding device 408 (discussed in further detail below). The at least one responding device 408 may be one or more UEs, one or more BSs, one or more IoT device, one or more wireless communication devices, or a combination thereof. The first COT initiating device 404 and/or the second COT initiating device 406 may transmit the corresponding COT sharing information to the device 402 via one or more SL channels.

In one aspect of the present disclosure, the first COT initiating device 404 may transmit the first COT sharing information 414 to the device 402. The second COT initiating device 406 may the transmit second COT sharing information 416 to the device 402. The device 402 may receive the first COT sharing information 414 and/or the second COT sharing information 416 in SCI from the SL transmissions. The device 402 may forward the first COT sharing information 414 and the second COT sharing information 416 to the at least one responding device 408 as the third COT sharing information 418. In other words, the third COT sharing information 418 may include the first COT sharing information 414 and the second COT sharing information 416. The at least one responding device 408 may utilize the COT sharing resources indicated in the third COT sharing information 418 for DL, UL, and/or SL transmission. In one aspect, the first COT initiating device 404 and/or the second COT initiating device 406 may be SL devices.

In some aspects of the present disclosure, the at least one responding device 408 may determine to use the COT sharing resources indicated in the third COT sharing information 418 for DL, UL, SL, or a combination thereof. The at least one responding device 408 may determine the start of the transmission. In other aspects, the device may control and/or configure the starting position of the DL/UL/SL transmissions by the at least one responding device 408. In some aspects, a responding device of the at least one responding device 408 with a higher prioritization has an earlier starting position than other devices.

In an aspect of the present disclosure, the device 402 may determine the allocations of the COT sharing resources for SL, UL, DL, or a combination thereof. The at least one responding device 408 may indicate the priority of the traffic to the device 402, and the device 402 may use the priority information to determine the allocation. In some cases, the device 402 may embed one or more bit fields (e.g., 2 bits added to the SCI) to the third COT sharing information 418 to indicate the type of transmission eligible to share the COT sharing resources. For example, “00” may indicate DL, “01” may indicate UL, “10” may indicated SL, and “11” may indicate that the at least one responding device 408 may determine how to use the COT sharing resources (i.e., for DL, UL, SL, or a combination thereof).

In a different aspect of the present disclosure, the device 402 may partition the COT sharing resources into two or more regions to support different types of transmissions separately. The device 402 may transmit an indication (e.g., slot format indication (SFI)) to indicate the type for each region of the COT sharing resources. For example, the device 402 may partition the COT sharing resources into two parts (in time domain), with a first part for UL transmission and a second part for SL transmission. Other partitioning schemes may also be implemented.

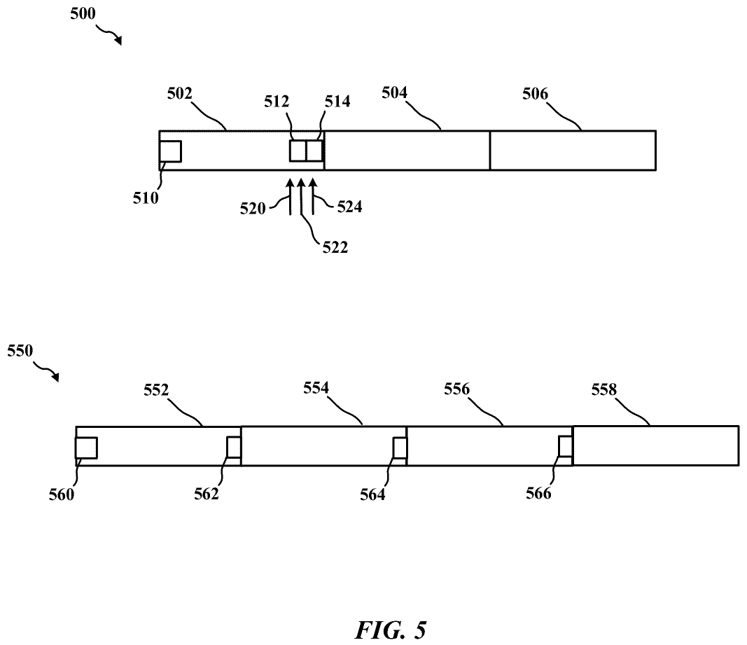

FIG. 5 illustrates examples of COT sharing resources allocated by initiating UEs.

In some aspects of the present disclosure, a device receiving the COT sharing information from multiple initiating devices may aggregate the COT sharing information and forward the information to responding devices for DL/UL/SL transmissions. The device may forward each information collectively or separately. In some instances, the aggregate COT sharing information may include UE identifier (ID) associated with each COT sharing information.

In certain aspects of the present disclosure, the device may combine the COT sharing resources of the initiating devices into and share the combined resources with the responding devices. When sharing the combined resources, the device may indicate the shared resource pattern (e.g., DL, SL, UL, or a combination thereof). The device may generate a new virtual bandwidth part (BWP) based on the available BWP, and use a bitmap to indicate the available LBT bandwidth. The device may update information relating to the virtual BWP and resource block (RB) information once the initiating devices vary.

In some aspects, and additionally referencing FIG. 4, a first example 500 includes first resources 502, second resources 504, and third resources 506. During the first resources 502, the device 402 may transmit first COT sharing information 510 via SCI to the at least one responding device 408. The first resources 502 may include first channel access resources 512 (e.g., type 2A channel access resources for LBT) and/or cyclic prefix (CP) extension 514. The first COT sharing information 510 may indicate, to the at least one responding device 408 that the second resources 504 and/or the third resources 506 are available for COT sharing. The second resources 504 and/or the third resources 506 may be allocated for UL, DL, SL, or a combination thereof. As described above, the allocation may be determined by the device 402, the first COT initiating device 404, the second COT initiating device 406 and/or the least one responding device 408. The at least one responding device 408 may perform channel access procedure (e.g., LBT) via the first channel access resources 512 to utilize some or all of the second resources 504 and/or the third resources 506 for COT sharing.

In some aspects of the present disclosure, a second example 550 includes fourth resources 552, fifth resources 554, sixth resources 556, and/or seventh resources 558. During the first resources 552, the device 402 may transmit second COT sharing information 560 via SCI to the at least one responding device 408. The fourth resources 552 may include second channel access resources 562. The second COT sharing information 560 may indicate, to the at least one responding device 408 that the fifth resources 554, the sixth resources 556, and/or the seventh resources 558 are available for COT sharing. The fifth resources 554 may be allocated for UL, the sixth resources 554 may be allocated for SL, and the seventh resources 558 may be allocated for DL. The at least one responding device 408 may perform channel access procedure (e.g., LBT) via the second channel access resources 562 to utilize some or all of the fifth resources 554 for UL COT sharing. Additionally or alternatively, the at least one responding device 408 may perform channel access procedure (e.g., LBT) via third channel access resources 564 to utilize some or all of the sixth resources 556 for SL COT sharing. Additionally or alternatively, the at least one responding device 408 may perform channel access procedure (e.g., LBT) via fourth channel access resources 566 to utilize some or all of the seventh resources 558 for DL COT sharing.

Referring to FIGS. 4 and 5, aspects of the present disclosure may include the device 402 determining which device to distribute the COT sharing resources among the at least one responding device 408 (if more than one). In some aspects, the device 402 may separately forward the first COT sharing information 414 and the second COT sharing information 416 to the at least one responding device 408 (e.g., SL COT sharing information). The forwarded first COT sharing information 414 and the second COT sharing information 416 may constitute the third COT sharing information 418.

In some aspects of the present disclosure, the third COT sharing information 418 may include information associated with the COT sharing resources. In one example, the third COT sharing information 418 may include a COT sharing starting time, a duration, and a frequency range, if the at least one responding device 408 determines how to use the COT sharing resources (e.g., for UL, DL, SL, or a combination thereof).

In another aspect, if the device 402 determines the COT sharing pattern, the third COT sharing information 418 may indicate the COT sharing pattern (e.g., for UL, DL, SL, or a combination thereof) as described above. For sharing resource allocation of SL-to-DL, the third COT sharing information 418 may indicate a table row index with SL-to-DL sharing. In certain implementations, a UL-to-DL COT sharing table may be reused for SL-to-DL sharing. In other implementations, a SL-to-DL sharing table may be used. In some aspects, for SL-to-DL or SL-to-SL/UL, the third COT sharing information 418 may indicate COT sharing information, such as a starting time, a duration, and/or a frequency range associated with the COT sharing resources.

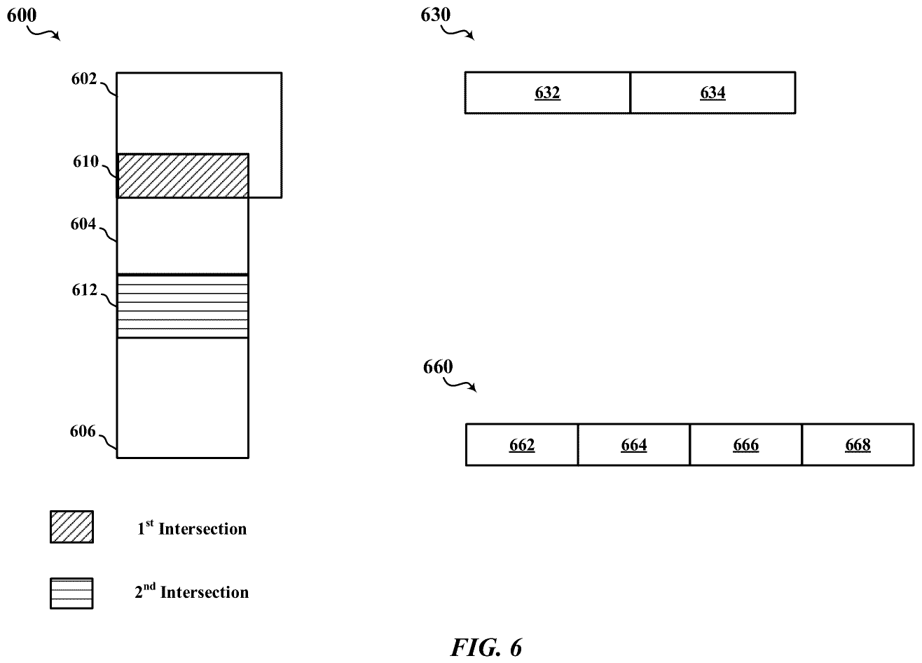

FIG. 6 illustrates an example of forwarding COT sharing resources. In some aspects of the present disclosure, the device may forward the intersection for COT sharing. For example, the device may select a subset of the initiating devices, form one or more intersections, and forward the one or more intersections for COT sharing. The device may provide one or more of the initiating device IDs, a list of initiating device IDs that satisfy the condition (or intersection), a list of some of the initiating device IDs (if the device is aware of which responding devices are able share the COT), etc. In some aspects, the device may aggregate the intersections into one COT sharing information. For each intersection, the COT sharing information may indicate the initiating device IDs and/or the resource allocation.

In some aspects of the present disclosure, and additionally referencing FIG. 4, COT sharing resources 600 may include first COT sharing resources 602, second COT sharing resources 604, and third COT sharing resources 606. The first COT sharing resources 602 and the second COT sharing resources 604 may have a first intersection 610 (in time and frequency). The second COT sharing resources 604 and the third COT sharing resources 606 may have a second intersection 612 (in time and frequency). The device 402 may receive COT sharing information indicating the COT sharing resources 600.

In one aspect of the present disclosure, the device 402 may transmit, to the at least one responding device 408, first COT sharing information 630 indicating first COT initiating device IDs 632 associated with the first COT sharing resources 602 and the second COT sharing resources 604, and first intersecting resources 634 in the first intersection 610. The device 402 may transmit the first COT sharing information 630 to the at least one responding device 408 for reasons indicated above. For example, the at least one responding device 408 may request a transmission type that is associated with the first COT sharing resources 602 and the second COT sharing resources 604.

In other aspects of the present disclosure, the device 402 may transmit, to the at least one responding device 408, second COT sharing information 660 indicating the first COT initiating device IDs 662 associated with the first COT sharing resources 602 and the second COT sharing resources 604, and the first intersecting resources 664 in the first intersection 610, and second COT initiating device IDs 666 associated with the second COT sharing resources 604 and the third COT sharing resources 606, and second intersecting resources 668 in the second intersection 612. The device 402 may transmit the second COT sharing information 660 to the at least one responding device 408 for reasons indicated above. For example, the device 402 may broadcast the COT sharing information to responding devices within a certain range/network.

In some aspects of the present disclosure, and referencing FIGS. 4-6, the device 402 may determine the energy detection (ED) threshold associated with the COT sharing resources. In some cases, the ED threshold may be utilized when the COT sharing resources are used by the BS 105 for DL transmissions. In one instance, the device 402 may reuse the same ED threshold as UL-to-DL. In other instances, the device 402 may identify a separate ED threshold configuration between UL and SL. For example, the device 402 may rely on a parameter sl-toDL-COT-SharingED-Threshold. If the parameter absenceOfAnyOtherTechnologv-r16 is not configured, and the parameter sl-toDL-COT-SharingED-Threshold is configured, the BS communicating with the device 402 may utilize the transmit power of the BS to determine the parameter sl-toDL-COT-SharingED-Threshold. If SL-to-DL sharing is enabled, the maximum threshold X_{Thres_max} may be set to equal to the value provided by the parameter sl-toDL-COT-SharingED-Threshold-r16, if provided. If sl-toDL-COT-SharingED-Threshold is not configured, the device 402 may determine the ED threshold based on UL-to-DL COT sharing.

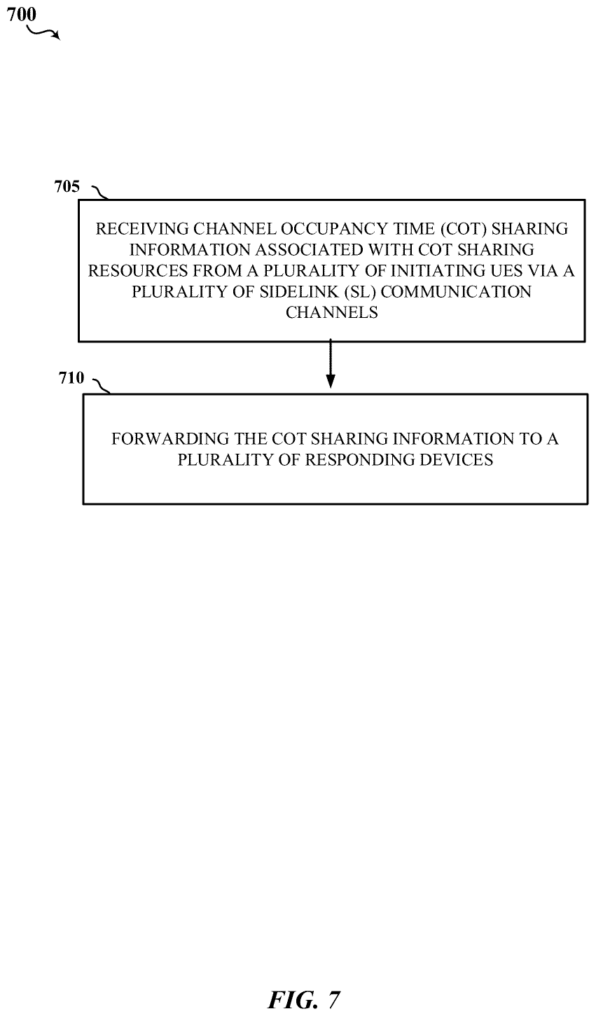

FIG. 7 illustrates an example of a method for COT resource sharing. For example, a method 700 may be performed by the one or more of the processor 212, the memory 216, the applications 275, the modem 220, the transceiver 202, the receiver 206, the transmitter 208, the RF front end 288, the communication component 222, and/or one or more other components of the UE 110 in the wireless communication network 100.

At block 705, the method 700 may receive channel occupancy time (COT) sharing information associated with COT sharing resources from a plurality of initiating UEs via a plurality of sidelink (SL) communication channels. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may receive channel occupancy time (COT) sharing information associated with COT sharing resources from a plurality of initiating UEs via a plurality of sidelink (SL) communication channels as described above.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving channel occupancy time (COT) sharing information associated with COT sharing resources from a plurality of initiating UEs via a plurality of sidelink (SL) communication channels. The RF front end 288 may receive the electrical signals converted from electro-magnetic signals. The RF front end 288 may filter and/or amplify the electrical signals. The transceiver 202 or the receiver 206 may convert the electrical signals to digital signals, and send the digital signals to the communication component 222.

At block 710, the method 700 may forward the COT sharing information to a plurality of responding devices. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may forward the COT sharing information to a plurality of responding devices as described above. The communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for forwarding the COT sharing information to a plurality of responding devices.

Alternatively or additionally, the method 700 may further include any of the methods above, wherein the plurality of responding devices includes at least one of one or more additional UEs or one or more base stations (BSs).

Alternatively or additionally, the method 700 may further include any of the methods above, further comprising identifying a first starting position of first resources of the COT sharing resources for a first responding device of the plurality of responding devices, identifying a second starting position of second resources of the COT sharing resources for a second responding device of the plurality of responding devices, and wherein forwarding the COT sharing information comprises transmitting, to the first responding device and the second responding device, indications indicating the first starting position and the second starting position.

Alternatively or additionally, the method 700 may further include any of the methods above, wherein the COT sharing information includes one or more bits indicating individual COT resources associated with each of the plurality of initiating UEs, and each of the individual COT resources is allocated for sidelink (SL), downlink (DL), or uplink (UL).

Alternatively or additionally, the method 700 may further include any of the methods above, further comprising identifying the COT sharing resources based on the COT sharing information, allocating one or more of first resources of the COT sharing resources for sidelink (SL) communication, second resources of the COT sharing resources for uplink (UL) communication, or third resources of the COT sharing resources for downlink (DL) communication, and transmitting control information indicating the first resources, the second resources, or the third resources to the plurality of responding devices.

Alternatively or additionally, the method 700 may further include any of the methods above, wherein forwarding the COT sharing information comprises forwarding corresponding COT sharing information (COT-SI) associated with each of the plurality of initiating UEs separately to the plurality of responding devices.

Alternatively or additionally, the method 700 may further include any of the methods above, wherein each corresponding COT-SI indicates a starting time, a duration, and a frequency range associated with corresponding COT sharing resources associated with each of the plurality of initiating UEs.

Alternatively or additionally, the method 700 may further include any of the methods above, wherein the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

Alternatively or additionally, the method 700 may further include any of the methods above, wherein each corresponding COT-SI indicates a starting time, a duration, and a frequency range associated with corresponding COT sharing resources associated with each of the plurality of initiating UEs.

Alternatively or additionally, the method 700 may further include any of the methods above, further comprising identifying a look-up table for sidelink-to-downlink COT sharing, and allocating the COT sharing resources for sidelink (SL), uplink (UL), downlink (DL), or a combination thereof based on the look-up table.

Alternatively or additionally, the method 700 may further include any of the methods above, wherein the look-up table is modified from an uplink-to-downlink COT sharing table.

Alternatively or additionally, the method 700 may further include any of the methods above, wherein forwarding the COT sharing information comprises aggregating corresponding COT sharing information (COT-SI) associated with each of the plurality of initiating UEs into aggregate COT-SI, and forwarding the aggregate COT-SI to the plurality of responding devices.

Alternatively or additionally, the method 700 may further include any of the methods above, wherein the aggregate COT-SI includes UE identifiers (IDs) associated with the plurality of initiating UEs.

Alternatively or additionally, the method 700 may further include any of the methods above, wherein forwarding the COT sharing information to the plurality of responding devices comprises forwarding the COT sharing information indicating the COT sharing resources allocated for sidelink (SL) communication, uplink (UL) communication, downlink (DL) communication, or a combination thereof.

Alternatively or additionally, the method 700 may further include any of the methods above, further comprising identifying each individual COT resources of a plurality of individual COT resources corresponding to an initiating UE of the plurality of initiating UEs, identifying at least one resource overlap of two or more of the plurality of individual COT resources, and wherein forwarding the COT sharing information comprises transmitting the resource overlap to the plurality of responding devices.

Alternatively or additionally, the method 700 may further include any of the methods above, further comprising, prior to identifying the at least one resource overlap, selecting a subset of the plurality of initiating UEs and wherein identifying the at least one resource overlap comprises identifying the at least one resource overlap of two or more of a subset of the plurality of individual COT resources each corresponding to an initiating UE of the subset of the plurality of initiating UEs.

Alternatively or additionally, the method 700 may further include any of the methods above, wherein forwarding the COT sharing information comprises aggregating the at least one resource overlap into an aggregate overlap and transmitting COT sharing information (COT-SI) indicating the aggregate overlap.

Alternatively or additionally, the method 700 may further include any of the methods above, further comprising identifying an energy detection threshold for sidelink-to-downlink COT sharing based on a sidelink-to-downlink energy detection threshold.

Alternatively or additionally, the method 700 may further include any of the methods above, wherein forwarding the COT sharing information to the plurality of responding devices comprises receiving an indication from at least one responding device of the plurality of responding devices indicating a subset of the COT sharing resources from a subset of the plurality of initiating UEs, and forwarding second COT sharing information indicating the subset of the COT sharing resources to the at least one responding device.

The methods above may be performed by the one or more of the processor 212, the memory 216, the applications 275, the modem 220, the transceiver 202, the receiver 206, the transmitter 208, the RF front end 288, the communication component 222, and/or one or more other components of the UE 110 in the wireless communication network 100.

### Additional Implementations

Aspects of the present disclosure include methods by a user equipment (UE) for receiving channel occupancy time (COT) sharing information associated with COT sharing resources from a plurality of initiating UEs via a plurality of sidelink (SL) communication channels, and forwarding the COT sharing information to a plurality of responding devices.

Any of the methods above, wherein the plurality of responding devices includes at least one of one or more additional UEs or one or more base stations (BSs).

Any of the methods above, further comprising identifying a first starting position of first resources of the COT sharing resources for a first responding device of the plurality of responding devices, identifying a second starting position of second resources of the COT sharing resources for a second responding device of the plurality of responding devices, and wherein forwarding the COT sharing information comprises transmitting, to the first responding device and the second responding device, indications indicating the first starting position and the second starting position.

Any of the methods above, wherein the COT sharing information includes one or more bits indicating individual COT resources associated with each of the plurality of initiating UEs, and each of the individual COT resources is allocated for sidelink (SL), downlink (DL), or uplink (UL).

Any of the methods above, further comprising identifying the COT sharing resources based on the COT sharing information, allocating one or more of first resources of the COT sharing resources for sidelink (SL) communication, second resources of the COT sharing resources for uplink (UL) communication, or third resources of the COT sharing resources for downlink (DL) communication, and transmitting control information indicating the first resources, the second resources, or the third resources to the plurality of responding devices.

Any of the methods above, wherein forwarding the COT sharing information comprises forwarding corresponding COT sharing information (COT-SI) associated with each of the plurality of initiating UEs separately to the plurality of responding devices.

Any of the methods above, wherein each corresponding COT-SI indicates a starting time, a duration, and a frequency range associated with corresponding COT sharing resources associated with each of the plurality of initiating UEs.

Any of the methods above, wherein the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

Any of the methods above, wherein each corresponding COT-SI indicates a starting time, a duration, and a frequency range associated with corresponding COT sharing resources associated with each of the plurality of initiating UEs.

Any of the methods above, further comprising identifying a look-up table for sidelink-to-downlink COT sharing, and allocating the COT sharing resources for sidelink (SL), uplink (UL), downlink (DL), or a combination thereof based on the look-up table.

Any of the methods above, wherein the look-up table is modified from an uplink-to-downlink COT sharing table.

Any of the methods above, wherein forwarding the COT sharing information comprises aggregating corresponding COT sharing information (COT-SI) associated with each of the plurality of initiating UEs into aggregate COT-SI, and forwarding the aggregate COT-SI to the plurality of responding devices.

Any of the methods above, wherein the aggregate COT-SI includes UE identifiers (IDs) associated with the plurality of initiating UEs.

Any of the methods above, wherein forwarding the COT sharing information to the plurality of responding devices comprises forwarding the COT sharing information indicating the COT sharing resources allocated for sidelink (SL) communication, uplink (UL) communication, downlink (DL) communication, or a combination thereof.

Any of the methods above, further comprising identifying each individual COT resources of a plurality of individual COT resources corresponding to an initiating UE of the plurality of initiating UEs, identifying at least one resource overlap of two or more of the plurality of individual COT resources, and wherein forwarding the COT sharing information comprises transmitting the resource overlap to the plurality of responding devices.

Any of the methods above, further comprising, prior to identifying the at least one resource overlap, selecting a subset of the plurality of initiating UEs and wherein identifying the at least one resource overlap comprises identifying the at least one resource overlap of two or more of a subset of the plurality of individual COT resources each corresponding to an initiating UE of the subset of the plurality of initiating UEs.

Alternatively or additionally, wherein forwarding the COT sharing information comprises aggregating the at least one resource overlap into an aggregate overlap and transmitting COT sharing information (COT-SI) indicating the aggregate overlap.

Any of the methods above, further comprising identifying an energy detection threshold for sidelink-to-downlink COT sharing based on a sidelink-to-downlink energy detection threshold.

Any of the methods above, wherein forwarding the COT sharing information to the plurality of responding devices comprises receiving an indication from at least one responding device of the plurality of responding devices indicating a subset of the COT sharing resources from a subset of the plurality of initiating UEs, and forwarding second COT sharing information indicating the subset of the COT sharing resources to the at least one responding device.

Other aspects of the present disclosure include a user equipment (UE) having a memory comprising instructions, a transceiver, and one or more processors operatively coupled with the memory and the transceiver, the one or more processors configured to execute instructions in the memory to receive channel occupancy time (COT) sharing information associated with COT sharing resources from a plurality of initiating UEs via a plurality of sidelink (SL) communication channels, and forward the COT sharing information to a plurality of responding devices.

Any of the UEs above, wherein the plurality of responding devices includes at least one of one or more additional UEs or one or more base stations (BSs).

Any of the UEs above, wherein the one or more processors are further configured to identify a first starting position of first resources of the COT sharing resources for a first responding device of the plurality of responding devices, identify a second starting position of second resources of the COT sharing resources for a second responding device of the plurality of responding devices, and wherein forwarding the COT sharing information comprises transmitting, to the first responding device and the second responding device, indications indicating the first starting position and the second starting position.

Any of the UEs above, wherein the COT sharing information includes one or more bits indicating individual COT resources associated with each of the plurality of initiating UEs, and each of the individual COT resources is allocated for sidelink (SL), downlink (DL), or uplink (UL).

Any of the UEs above, wherein the one or more processors are further configured to identify the COT sharing resources based on the COT sharing information, allocate one or more of first resources of the COT sharing resources for sidelink (SL) communication, second resources of the COT sharing resources for uplink (UL) communication, or third resources of the COT sharing resources for downlink (DL) communication, and transmit control information indicating the first resources, the second resources, or the third resources to the plurality of responding devices.

Any of the UEs above, wherein forwarding the COT sharing information comprises forward corresponding COT sharing information (COT-SI) associated with each of the plurality of initiating UEs separately to the plurality of responding devices.

Any of the UEs above, wherein each corresponding COT-SI indicates a starting time, a duration, and a frequency range associated with corresponding COT sharing resources associated with each of the plurality of initiating UEs.

Any of the UEs above, wherein the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

Any of the UEs above, wherein each corresponding COT-SI indicates a starting time, a duration, and a frequency range associated with corresponding COT sharing resources associated with each of the plurality of initiating UEs.

Any of the UEs above, wherein the one or more processors are further configured to identify a look-up table for sidelink-to-downlink COT sharing, and allocate the COT sharing resources for sidelink (SL), uplink (UL), downlink (DL), or a combination thereof based on the look-up table.

Any of the UEs above, wherein the look-up table is modified from an uplink-to-downlink COT sharing table.

Any of the UEs above, wherein forwarding the COT sharing information comprises aggregate corresponding COT sharing information (COT-SI) associated with each of the plurality of initiating UEs into aggregate COT-SI, and forward the aggregate COT-SI to the plurality of responding devices.

Any of the UEs above, wherein the aggregate COT-SI includes UE identifiers (IDs) associated with the plurality of initiating UEs.

Any of the UEs above, wherein forwarding the COT sharing information to the plurality of responding devices comprises forward the COT sharing information indicating the COT sharing resources allocated for sidelink (SL) communication, uplink (UL) communication, downlink (DL) communication, or a combination thereof.

Any of the UEs above, wherein the one or more processors are further configured to identify each individual COT resources of a plurality of individual COT resources corresponding to an initiating UE of the plurality of initiating UEs, identify at least one resource overlap of two or more of the plurality of individual COT resources, and wherein forwarding the COT sharing information comprises transmitting the resource overlap to the plurality of responding devices.

Any of the UEs above, further comprising, prior to identifying the at least one resource overlap, selecting a subset of the plurality of initiating UEs and wherein identifying the at least one resource overlap comprises identifying the at least one resource overlap of two or more of a subset of the plurality of individual COT resources each corresponding to an initiating UE of the subset of the plurality of initiating UEs.

Any of the UEs above, wherein forwarding the COT sharing information comprises aggregating the at least one resource overlap into an aggregate overlap and transmitting COT sharing information (COT-SI) indicating the aggregate overlap.

Any of the UEs above, further comprising identifying an energy detection threshold for sidelink-to-downlink COT sharing based on a sidelink-to-downlink energy detection threshold.

Any of the UEs above, wherein forwarding the COT sharing information to the plurality of responding devices comprises receiving an indication from at least one responding device of the plurality of responding devices indicating a subset of the COT sharing resources from a subset of the plurality of initiating UEs, and forwarding second COT sharing information indicating the subset of the COT sharing resources to the at least one responding device.

An aspect of the present disclosure includes a user equipment (UE) including means for receiving channel occupancy time (COT) sharing information associated with COT sharing resources from a plurality of initiating UEs via a plurality of sidelink (SL) communication channels, and means for forwarding the COT sharing information to a plurality of responding devices.

Any of the UEs above, wherein the plurality of responding devices includes at least one of one or more additional UEs or one or more base stations (BSs).

Any of the UEs above, further comprising means for identifying a first starting position of first resources of the COT sharing resources for a first responding device of the plurality of responding devices, means for identifying a second starting position of second resources of the COT sharing resources for a second responding device of the plurality of responding devices, and wherein means for forwarding the COT sharing information comprises means for transmitting, to the first responding device and the second responding device, indications indicating the first starting position and the second starting position.

Any of the UEs above, wherein the COT sharing information includes one or more bits indicating individual COT resources associated with each of the plurality of initiating UEs, and each of the individual COT resources is allocated for sidelink (SL), downlink (DL), or uplink (UL).

Any of the UEs above, further comprising means for identifying the COT sharing resources based on the COT sharing information, means for allocating one or more of first resources of the COT sharing resources for sidelink (SL) communication, second resources of the COT sharing resources for uplink (UL) communication, or third resources of the COT sharing resources for downlink (DL) communication, and means for transmitting control information indicating the first resources, the second resources, or the third resources to the plurality of responding devices.

Any of the UEs above, wherein means for forwarding the COT sharing information comprises means for forwarding corresponding COT sharing information (COT-SI) associated with each of the plurality of initiating UEs separately to the plurality of responding devices.

Any of the UEs above, wherein each corresponding COT-SI indicates a starting time, a duration, and a frequency range associated with corresponding COT sharing resources associated with each of the plurality of initiating UEs.

Any of the UEs above, wherein the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

Any of the UEs above, wherein each corresponding COT-SI indicates a starting time, a duration, and a frequency range associated with corresponding COT sharing resources associated with each of the plurality of initiating UEs.

Any of the UEs above, further comprising means for identifying a look-up table for sidelink-to-downlink COT sharing, and means for allocating the COT sharing resources for sidelink (SL), uplink (UL), downlink (DL), or a combination thereof based on the look-up table.

Any of the UEs above, wherein the look-up table is modified from an uplink-to-downlink COT sharing table.

Any of the UEs above, wherein means for forwarding the COT sharing information comprises means for aggregating corresponding COT sharing information (COT-SI) associated with each of the plurality of initiating UEs into aggregate COT-SI, and means for forwarding the aggregate COT-SI to the plurality of responding devices.

Any of the UEs above, wherein the aggregate COT-SI includes UE identifiers (IDs) associated with the plurality of initiating UEs.

Any of the UEs above, wherein means for forwarding the COT sharing information to the plurality of responding devices comprises means for forwarding the COT sharing information indicating the COT sharing resources allocated for sidelink (SL) communication, uplink (UL) communication, downlink (DL) communication, or a combination thereof.

Any of the UEs above, further comprising means for identifying each individual COT resources of a plurality of individual COT resources corresponding to an initiating UE of the plurality of initiating UEs, means for identifying at least one resource overlap of two or more of the plurality of individual COT resources, and wherein means for forwarding the COT sharing information comprises means for transmitting the resource overlap to the plurality of responding devices.

Any of the UEs above, further comprising, prior to identifying the at least one resource overlap, means for selecting a subset of the plurality of initiating UEs and wherein means for identifying the at least one resource overlap comprises means for identifying the at least one resource overlap of two or more of a subset of the plurality of individual COT resources each corresponding to an initiating UE of the subset of the plurality of initiating UEs.

Any of the UEs above, wherein means for forwarding the COT sharing information comprises means for aggregating the at least one resource overlap into an aggregate overlap and transmitting COT sharing information (COT-SI) indicating the aggregate overlap.

Any of the UEs above, further comprising means for identifying an energy detection threshold for sidelink-to-downlink COT sharing based on a sidelink-to-downlink energy detection threshold.

Any of the UEs above, wherein means for forwarding the COT sharing information to the plurality of responding devices comprises means for receiving an indication from at least one responding device of the plurality of responding devices indicating a subset of the COT sharing resources from a subset of the plurality of initiating UEs, and means for forwarding second COT sharing information indicating the subset of the COT sharing resources to the at least one responding device.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a user equipment (UE) in a network, comprising:
receiving channel occupancy time (COT) sharing information associated with COT sharing resources from a plurality of initiating UEs via a plurality of sidelink (SL) communication channels; and
forwarding the COT sharing information to a plurality of responding devices.

2. The method of claim 1, wherein:
the plurality of responding devices includes at least one of one or more additional UEs or one or more base stations (BSs).

3. The method of claim 1, further comprising:
identifying a first starting position of first resources of the COT sharing resources for a first responding device of the plurality of responding devices;
identifying a second starting position of second resources of the COT sharing resources for a second responding device of the plurality of responding devices; and
wherein forwarding the COT sharing information comprises transmitting, to the first responding device and the second responding device, indications indicating the first starting position and the second starting position.

4. The method of claim 1, wherein the COT sharing information includes one or more bits indicating:
individual COT resources associated with each of the plurality of initiating UEs; and
each of the individual COT resources is allocated for sidelink (SL), downlink (DL), or uplink (UL).

5. The method of claim 1, further comprising:
identifying the COT sharing resources based on the COT sharing information;
allocating one or more of first resources of the COT sharing resources for sidelink (SL) communication, second resources of the COT sharing resources for uplink (UL) communication, or third resources of the COT sharing resources for downlink (DL) communication; and
transmitting control information indicating the first resources, the second resources, or the third resources to the plurality of responding devices.

6. The method of claim 1, wherein forwarding the COT sharing information comprises:
forwarding corresponding COT sharing information (COT-SI) associated with each of the plurality of initiating UEs separately to the plurality of responding devices.

7. The method of claim 6, wherein:
each corresponding COT-SI indicates a starting time, a duration, and a frequency range associated with corresponding COT sharing resources associated with each of the plurality of initiating UEs.

8. The method of claim 1, wherein:
the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

9. The method of claim 8, wherein:
each corresponding COT-SI indicates a starting time, a duration, and a frequency range associated with corresponding COT sharing resources associated with each of the plurality of initiating UEs.

10. The method of claim 1, further comprising:
identifying a look-up table for sidelink-to-downlink COT sharing; and
allocating the COT sharing resources for sidelink (SL), uplink (UL), downlink (DL), or a combination thereof based on the look-up table.

11. The method of claim 10, wherein:
the look-up table is modified from an uplink-to-downlink COT sharing table.

12. The method of claim 1, wherein forwarding the COT sharing information comprises:
aggregating corresponding COT sharing information (COT-SI) associated with each of the plurality of initiating UEs into aggregate COT-SI; and
forwarding the aggregate COT-SI to the plurality of responding devices.

13. The method of claim 12, wherein:
the aggregate COT-SI includes UE identifiers (IDs) associated with the plurality of initiating UEs.

14. The method of claim 1, wherein forwarding the COT sharing information to the plurality of responding devices comprises:
forwarding the COT sharing information indicating the COT sharing resources allocated for sidelink (SL) communication, uplink (UL) communication, downlink (DL) communication, or a combination thereof.

15. The method of claim 1, further comprising:
identifying each individual COT resources of a plurality of individual COT resources corresponding to an initiating UE of the plurality of initiating UEs;
identifying at least one resource overlap of two or more of the plurality of individual COT resources; and
wherein forwarding the COT sharing information comprises transmitting the resource overlap to the plurality of responding devices.

16. The method of claim 15, further comprising, prior to identifying the at least one resource overlap:
selecting a subset of the plurality of initiating UEs; and
wherein identifying the at least one resource overlap comprises identifying the at least one resource overlap of two or more of a subset of the plurality of individual COT resources each corresponding to an initiating UE of the subset of the plurality of initiating UEs.

17. The method of claim 15, wherein forwarding the COT sharing information comprises:
aggregating the at least one resource overlap into an aggregate overlap; and
transmitting COT sharing information (COT-SI) indicating the aggregate overlap.

18. The method of claim 1, further comprising:
identifying an energy detection threshold for sidelink-to-downlink COT sharing based on a sidelink-to-downlink energy detection threshold.

19. The method of claim 1, wherein forwarding the COT sharing information to the plurality of responding devices comprises:
receiving an indication from at least one responding device of the plurality of responding devices indicating a subset of the COT sharing resources from a subset of the plurality of initiating UEs; and
forwarding second COT sharing information indicating the subset of the COT sharing resources to the at least one responding device.

20. A user equipment (UE), comprising:
a memory comprising instructions;
a transceiver; and
one or more processors operatively coupled with the memory and the transceiver, the one or more processors configured to execute instructions in the memory to:
receive channel occupancy time (COT) sharing information associated with COT sharing resources from a plurality of initiating UEs via a plurality of sidelink (SL) communication channels; and
forward the COT sharing information to a plurality of responding devices.

21. The UE of claim 20, wherein:
the plurality of responding devices includes at least one of one or more additional UEs or one or more base stations (BSs).

22. The UE of claim 20, wherein the one or more processors are further configured to:
identify a first starting position of first resources of the COT sharing resources for a first responding device of the plurality of responding devices;
identify a second starting position of second resources of the COT sharing resources for a second responding device of the plurality of responding devices; and
wherein forwarding the COT sharing information comprises transmitting, to the first responding device and the second responding device, indications indicating the first starting position and the second starting position.

23. The UE of claim 20, wherein the COT sharing information includes one or more bits indicating:
individual COT resources associated with each of the plurality of initiating UEs; and
each of the individual COT resources is allocated for sidelink (SL), downlink (DL), or uplink (UL).

24. The UE of claim 20, wherein the one or more processors are further configured to:
identify the COT sharing resources based on the COT sharing information;
allocate one or more of first resources of the COT sharing resources for sidelink (SL) communication, second resources of the COT sharing resources for uplink (UL) communication, or third resources of the COT sharing resources for downlink (DL) communication; and
transmit control information indicating the first resources, the second resources, or the third resources to the plurality of responding devices.

25. The UE of claim 20, wherein forwarding the COT sharing information comprises:
forward corresponding COT sharing information (COT-SI) associated with each of the plurality of initiating UEs separately to the plurality of responding devices.

26. The UE of claim 25, wherein:
each corresponding COT-SI indicates a starting time, a duration, and a frequency range associated with corresponding COT sharing resources associated with each of the plurality of initiating UEs.

27. The UE of claim 20, wherein:
the COT sharing information includes corresponding COT sidelink sharing information (COT-SI) associated with each of the plurality of initiating UEs, the corresponding COT-SI indicating corresponding individual COT resources of the COT sharing resources being allocated for sidelink (SL) communication, uplink (UL) communication, downlink (DL) communication, or a combination thereof.

28. A non-transitory computer readable medium having instructions stored therein that, when executed by one or more processors of a user equipment (UE), cause the one or more processors to:
receive channel occupancy time (COT) sharing information associated with COT sharing resources from a plurality of initiating UEs via a plurality of sidelink (SL) communication channels; and
forward the COT sharing information to a plurality of responding devices.

29. A user equipment (UE), comprising:
means for receiving channel occupancy time (COT) sharing information associated with COT sharing resources from a plurality of initiating UEs via a plurality of sidelink (SL) communication channels; and
means for forwarding the COT sharing information to a plurality of responding devices.
